(19) United States
(12) Patent Application Publication
(10) Pub. No.: US 2026/0164229 A1
(43) Pub. Date: Jun. 11, 2026

(54) REMOVING IMS PROFILES FOR UES CONNECTING TO NON-IMS NETWORKS

(71) Applicant: T-Mobile USA, Inc., Bellevue, WA (US)

(72) Inventor: Romil Sood, Bellevue, WA (US)

(21) Appl. No.: 18/977,588

(22) Filed: Dec. 11, 2024

(51) Int. Cl. H04W 8/18; H04W 60/04; H04W 76/30

(52) U.S. Cl. CPC H04W 8/183; H04W 60/04; H04W 76/30

(57) ABSTRACT

Described herein is a subscriber database node configured to determine that a user equipment (UE) is connected to a non-Internet Protocol Multimedia System (non-IMS) network and to, in response, instruct an IMS node to delete an IMS profile associated with the UE. The subscriber database may determine the network of the UE in response to receiving a message associated with the UE, such as an update location request or a session termination message. When the message is an update location request, the subscriber database may check information in a data store to determine that the UE is connected to a non-IMS network.

### BACKGROUND

Packet-switched calls may be placed using Internet Protocol Multimedia Subsystems (IMS) networks or other Voice over Packet-Switched (VoPS) networks. The user equipment (UE) placing those calls may subsequently connect to a non-IMS or non-VoPS network. An IMS profile from the previous IMS/VoPS connection may still be maintained by an IMS node (e.g., a serving call session control function (S-CSCF)), however. When a new call is placed to the UE, the IMS profile may result in connectivity difficulties, as the UE is then connected to a non-IMS/non-VoPS network (e.g., a non-terrestrial network (NTN)).

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 is a network diagram showing a telecommunications network and a user equipment (UE) successively connected to the telecommunications network through an Internet Protocol Multimedia Subsystem (IMS) network followed by a non-IMS network and showing a subscriber database node of the telecommunications network configured to delete an IMS profile of the UE from an IMS node of the telecommunications network.

FIG. 2 is a call flow diagram showing two message sets associated with a subscriber database node determining that a UE is connected to a non-Voice over Packet-Switched (VoPS) network and instructing an IMS node to delete an IMS profile of the UE.

FIG. 3 is a flow diagram of an illustrative process for determining, based on receiving a session termination message associated with a UE, that the UE is connected to a non-IMS network and, in response, instructing an IMS node to delete an IMS profile of the UE.

FIG. 4 is a flow diagram of an illustrative process for determining, based on receiving an update location request for a UE and on checking a data store listing IMS networks (or non-IMS networks), that a UE is connected to a non-IMS network and, in response, instructing an IMS node to delete an IMS profile of the UE.

FIG. 5 is a flow diagram of an illustrative process for a policy node to receive a session termination message associated with a UE and to instruct a subscriber database node to delete an IMS profile of the UE from an IMS node.

FIG. 6 is a schematic diagram of a computing device capable of implementing functionality of at least one of the subscriber database node or the policy node.

### DETAILED DESCRIPTION

This disclosure is directed in part to a subscriber database node (e.g., a home subscriber server (HSS)) and policy node (e.g., a policy and charging rules function (PCRF)). The subscriber database node receives a message-either a session termination message from the policy node or an update location request from another telecommunications network node—and determines in response whether a user equipment (UE) associated with the message is connected to a non-Voice over Packet-Switched (non-VoPS) network (also referred to herein as a non-Internet Protocol Multimedia Subsystem (non-IMS) network). When the subscriber database node determines that the UE is connected to a non-VoPS network, the subscriber database node instructs an IMS node (e.g., a serving call session control function (S-CSCF)) to delete an IMS profile for the UE stored on or accessible to that IMS node.

In various implementations, the message received by the subscriber database node may have been sent to the subscriber database node by the policy node in response to the policy node receiving, from a packet gateway (e.g. a packet data network gateway (PGW)), a message related to IMS session termination. The packet gateway may send such a message to the policy node in response to a delete session request. When the subscriber database node receives a message associated with IMS session termination from the policy node, it sends instructions to an IMS node to delete the IMS profile associated with the IMS session.

In additional or alternative implementations, the message received by the subscriber database node is an update location request associated with a UE and received from a node of the telecommunications network (e.g., a mobility management entity (MME)). Upon receiving the message, the subscriber database node determines an identifier of a network connected to the UE and checks a table storing identifiers of non-VoPS networks (or, alternatively, identifiers of VoPS networks) to determine if the network is listed (or not listed there)—indicating that the network is a non-VoPS network. In response, the subscriber database node sends instructions to an IMS node to delete the IMS profile associated with the UE.

As used herein, “non-IMS network” refers to a telecommunications network that does not include an IMS and which either does not support packet-switched communications or which supports packet-switched communications in some other manner (i.e., supports those communications without an IMS). It is often used interchangeably herein with “non-VoPS network”, as a non-IMS network often does not support VoPS and thus is also a non-VoPS network. While there is some difference between a network which does not support VoPS and a network which does not include an IMS, for the purposes described herein, the terms non-IMS and non-VoPS (as well as IMS and VoPS) may be used interchangeably.

Deleting an IMS profile, clearing an IMS profile, removing an IMS profile, etc. are used interchangeably herein. Data store, mapping, table, etc. are also used interchangeably herein.

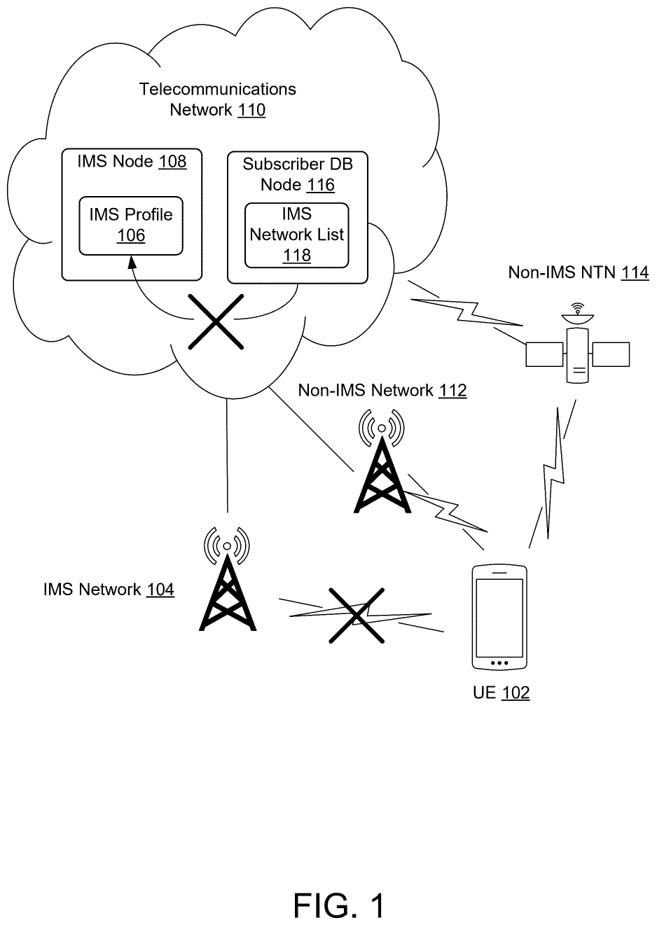

FIG. 1 is a network diagram showing a telecommunications network and a user equipment (UE) successively connected to the telecommunications network through an Internet Protocol Multimedia Subsystem (IMS) network followed by a non-IMS network and showing a subscriber database node of the telecommunications network configured to delete an IMS profile of the UE from an IMS node of the telecommunications network. As illustrated, a UE 102 may initially be connected to an IMS network 104, resulting in the creation of an IMS profile 106 maintained by an IMS node 108 of a telecommunications network 110. Subsequently, the UE 102 may connect to a non-IMS network 112 or non-IMS NTN 114. The change of connectivity to a non-IMS network 112 or non-IMS NTN 114 may result in a subscriber database node 116 instructing the IMS node 108 to delete the IMS profile 106. In some implementations, the subscriber database node 116 may do so based on checking an IMS network list 118 to determine that the UE 102 is connected to a non-IMS network 112 or a non-IMS NTN 114.

The UE 102 may be any sort of wireless communication device, such as a cellular phone, a tablet computer, an Internet-of-Things (IoT) device (e.g., a watch, glasses, goggles, etc.), a gaming device, etc. The user of the UE 102 may subscribe for services of a network operator of the telecommunications network 110. As shown in FIG. 1, the UE 102 may connect to different access networks (e.g., those of IMS network 104, non-IMS network 112, and non-IMS NTN 114) at different times. Changes of connection may result from moving from one location to another, from a change in the service that the UE 102 is using, from a change in connectivity metrics, etc.

In various implementations, each of the networks (e.g., IMS network 104, non-IMS network 112, and non-IMS NTN 114) may comprise at least an access network. IMS network 104 may be an access network of the telecommunications network 110 or may comprise both an access network and core network of an IMS-supporting network that the UE 102 has roamed to. Non-IMS network 112 and non-IMS NTN 114 may each be an access network that does not support IMS signaling (i.e., SIP messages). The non-IMS network 112 and non-IMS NTN 114 may also comprise a core network and may be a network that the UE 102 has roamed to. Non-IMS network 112 may be a terrestrial network provided by, e.g., a base station, a WiFi router, etc. and non-IMS NTN 114 may be a non-terrestrial network provided by, e.g., a satellite.

The telecommunications network 110 may be a home network of the UE 102 and include a core network of the home network. The core network may include components such as mobility management entities (MMEs), an equipment identity register (EIR), a packet data network gateways (PGW), a serving gateway (SGW), a policy node, such as a policy and charging rules function (PCRF), and a subscriber database node 116, such as a home subscriber server (HSS). These names each reflect specific generation(s) of cellular technology; it is to be understood that they also represent/cover their predecessor and successor nodes/functions (in prior or later generations) with same or similar purposes. For example, the policy node may be a policy control function (PCF) or a PCRF, and the subscriber database node 116 may be any of a home location register (HLR), an HSS, or a unified data repository (UDR). The telecommunications network 110 may also include an IMS with at least the IMS node 108. The IMS may include call session control functions (CSCF), such as a proxy CSCF (P-CSCF), a serving CSCF (S-CSCF), and an interrogating CSCF (I-CSCF). One of the CSCFs, such as the S-CSCF, may be implemented by the IMS node 108 and may store an IMS profile 106 for the UE 102 from a past IMS session of the UE 102.

In various implementations, retention of the IMS profile 106 by the telecommunications network 110 may cause delay in call set-up or call failure for calls to the UE 102 when the UE is connected to the non-IMS network 112 or non-IMS NTN 114. Resolution of this issue may be achieved, as described herein, by having the subscriber database node 116 instruct the IMS node 108 to delete the IMS profile 106. In some embodiments, these instructions are triggered upon termination of an IMS session and connection to the non-IMS network 112 or non-IMS NTN 114 by either a delete session request or an update location request.

In some implementations, following a change of connection to a non-IMS network 112 or non-IMS NTN 114, a new MME of the UE 102 may send a delete session request to a PGW of the telecommunications network. The PGW may in turn send a message to the policy node (e.g., PCRF), such as a Policy and Charging Enforcement Function (PCEF)-Initiated IP Connectivity Access Network (IP-CAN) session termination. Upon receiving this message, the policy node may communicate a session termination message to the subscriber database node 116. Such a session termination message may, for example, be a lightweight directory access protocol (LDAP) message. Upon receiving this message, the subscriber database node 116 determines the message's association with the UE 102 and sends instructions to the IMS node 108 (e.g., S-CSCF) to delete the IMS profile 106.

In alternative or additional implementations, following a change of connection to a non-IMS network 112 or non-IMS NTN 114, a new MME of the UE 102 may send an update location request to the subscriber database node 116. Upon receiving the update location request, the subscriber database node 116 may retrieve a visited public land mobile number (PLMN) attribute-value pair (AVP) from an S6a registration message associated with the update location request. The subscriber database node 116 may maintain an IMS network list 118 (also referred to herein as a “table” or “data store”) with mobile country codes (MCCs) or mobile network codes (MNCs) for IMS networks, for non-IMS networks, or with both, but with a flag value distinguishing the IMS networks and non-IMS networks. The subscriber database node 116 may compare the visited PLMN AVP to the entries in the IMS network list 118 to determine whether the UE 102 is connected to a non-IMS network 112 or non-IMS NTN 114. When the UE 102 is connected to a non-IMS network 112 or non-IMS NTN 114, the subscriber database node 116 sends instructions to the IMS node 108 (e.g., S-CSCF) to delete the IMS profile 106.

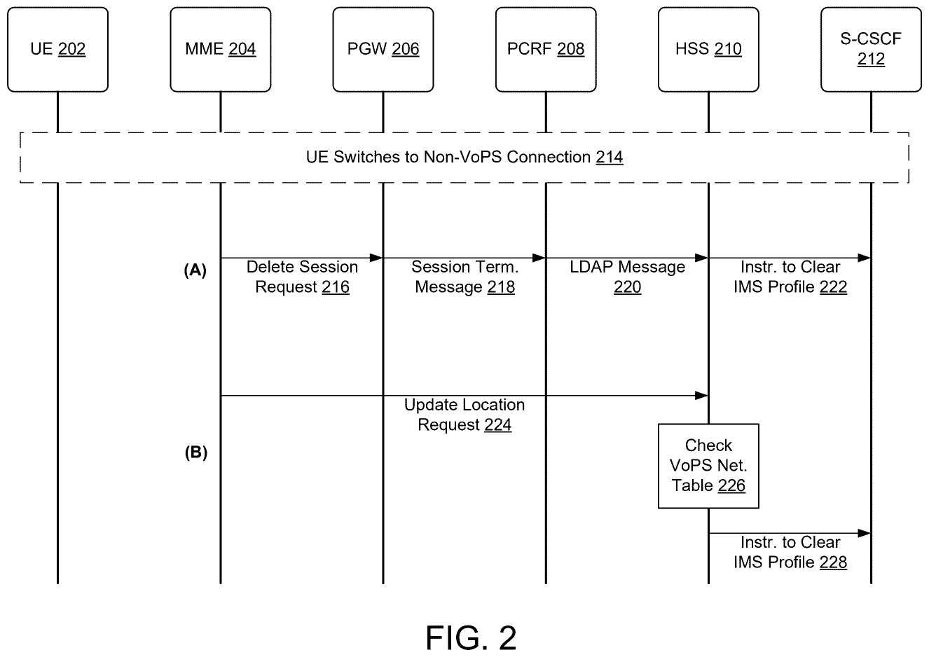

FIG. 2 is a call flow diagram showing two message sets associated with a subscriber database node determining that a UE is connected to a non-Voice over Packet-Switched (VoPS) network and instructing an IMS node to delete an IMS profile of the UE. As shown, a UE 202, MME 204, PGW 206, PCRF 208, HSS 210, and S-CSCF 212 may exchange messages leading to the deletion, at the S-CSCF 212, of an IMS profile for the UE 202.

In various implementations, the UE 202 may be an example of the UE 102, the PCRF 208 may be an example of the policy node, the HSS 210 may be an example of the subscriber database node 116, and the S-CSCF 212 may be an example of the IMS node 108. The two additional nodes mentioned—the MME 204 and PGW 206—are also mentioned herein with respect to FIG. 1 (as examples of nodes that may comprise part of the telecommunications network 110).

As further discussed herein, the UE 202 may switch to a non-VoPS network, at 214, from a previous connection to an IMS network. In some examples, the UE 202 may roam to the non-VoPS network, which may be terrestrial or non-terrestrial. This roaming to a non-VoPS network may result in message exchanges, such as those shown at (A) and (B) in FIG. 2.

With respect to message exchange (A), the MME 204, which may be a new MME of the UE 202 (e.g., an MME associated with the non-VoPS network) may send a delete session request message 216 to the PGW 206 of the UE 202's home network. The PGW 206 may, in turn, send a session termination message 218 (e.g., a PCEF-Initiated IP-CAN session termination message) to the PCRF 208. When the PCRF 208 receives the session termination message 218, the PCRF 208 send a message 220 to the HSS 210. Such a message 220 may be a LDAP message (e.g., a sh/API/LDAP message). Upon receiving the message 220, the HSS 210 determines the UE 202 associated with the messages 216-220, determines the S-CSCF 212 associated with the UE 202, and instructs, at 222, the S-CSCF 212 to clear the IMS profile for the UE 202.

For message exchange (B), the MME 204, which may be a new MME of the UE 202 (e.g., an MME associated with the non-VoPS network) may send an update location request message 224 to the HSS 210. The HSS 210 may in turn determine information about the network that the UE 202 is connected to, such as a network identifier. In some examples, this information may be a visited PLMN AVP taken from an S6a registration message. At 226, the HSS 210 then checks a VoPS network table. The table can list MCCs/MNCs for either non-VoPS networks or VoPS networks. If it lists both, each entry may include (or not include) a flag value based on its membership in one of those categories (e.g., non-VoPS) so that non-VoPS networks are effectively identified. Using the information for the UE 202's network and the table, the HSS 210 may determine whether the UE 202 is connected to a non-VoPS network. When the UE 202 is connected to a non-VoPS network, the HSS 210 instructs, at 228, the S-CSCF 212 to clear the IMS profile for the UE 202.

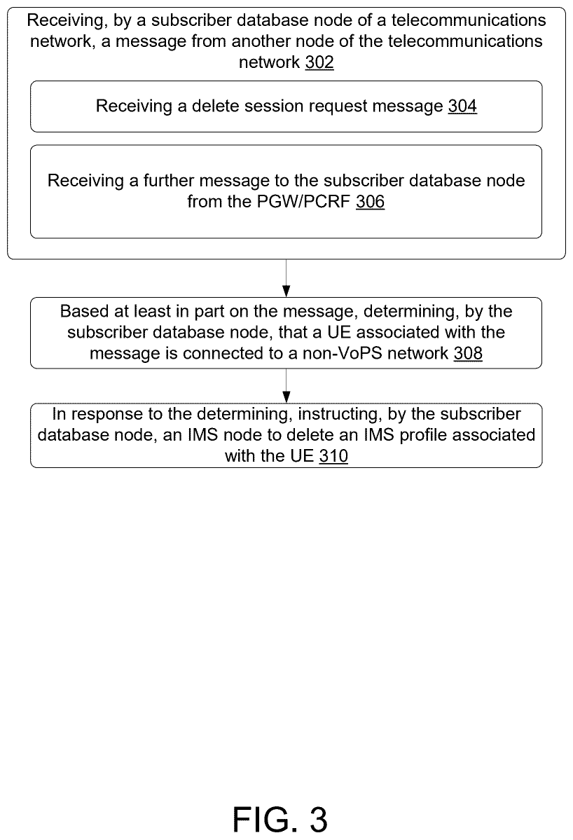

FIGS. 3-5 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for determining, based on receiving a session termination message associated with a UE, that the UE is connected to a non-IMS network and, in response, instructing an IMS node to delete an IMS profile of the UE. As illustrated at 302, a subscriber database node of a telecommunications network receives a message from another node of the telecommunications network. In some implementations, the subscriber database node may be a home subscriber server. Also, the message may include a session termination message for an IMS session of the UE. At 304, the receiving may comprise receiving a message associated with a delete session request. At 306, the receiving may further comprise receiving a further message from a PGW/PCRF in response to the PGW/PCRF receiving a delete session request.

At 308, based at least in part on the message, the subscriber database node determines that a UE associated with the message is connected to a non-VoPS network. In some implementations, the non-VoPS network may be an NTN.

At 310, in response to the determining, the subscriber database node instructs an IMS node to delete an IMS profile associated with the UE.

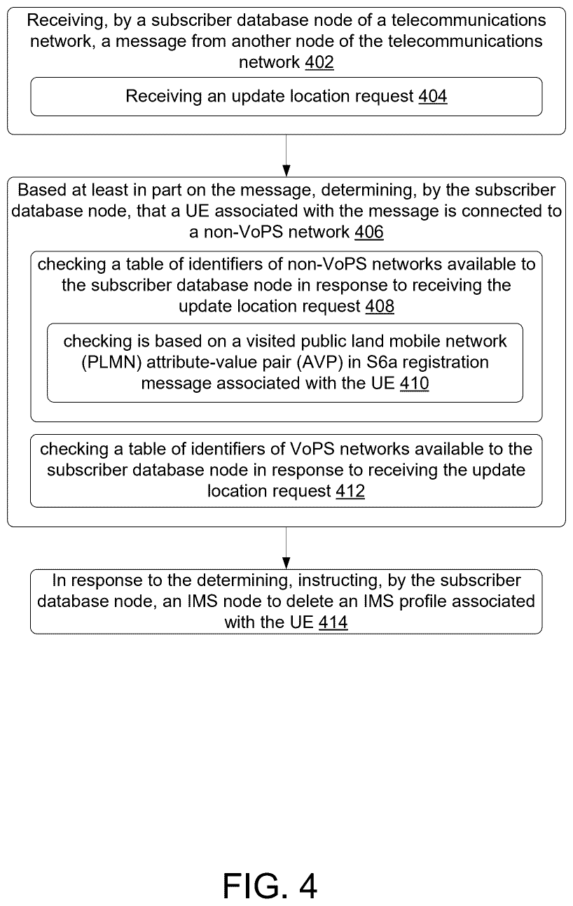

FIG. 4 is a flow diagram of an illustrative process for determining, based on receiving an update location request for a UE and on checking a data store listing IMS networks (or non-IMS networks), that a UE is connected to a non-IMS network and, in response, instructing an IMS node to delete an IMS profile of the UE. As illustrated at 402, a subscriber database node of a telecommunications network receives a message from another node of the telecommunications network. In some implementations, the subscriber database node may be a home subscriber server. At 404, the message may be an update location request and the receiving may comprise receiving the update location request.

At 406, based at least in part on the message, the subscriber database node determines that a UE associated with the message is connected to a non-VoPS network. In some implementations, the non-VoPS network may be a non-terrestrial network. At 408, the determining may comprise checking a table of identifiers of non-VoPS networks available to the subscriber database node in response to receiving the update location request. At 410, the checking may be based on a visited PLMN AVP in S6a registration message associated with the UE. In some implementations, the table may list MCCs and/or MNCs of networks as the identifiers. Further, the table may list MCCs/MNCs of both IMS and non-IMS networks, and either the IMS networks or the non-IMS networks may be indicated by flag values. At 412, the determining may comprise checking a table of identifiers of VoPS networks available to the subscriber database node in response to receiving the update location request.

At 414, in response to the determining, the subscriber database node instructs an IMS node to delete an IMS profile associated with the UE. In some implementations, the serving node is an S-CSCF.

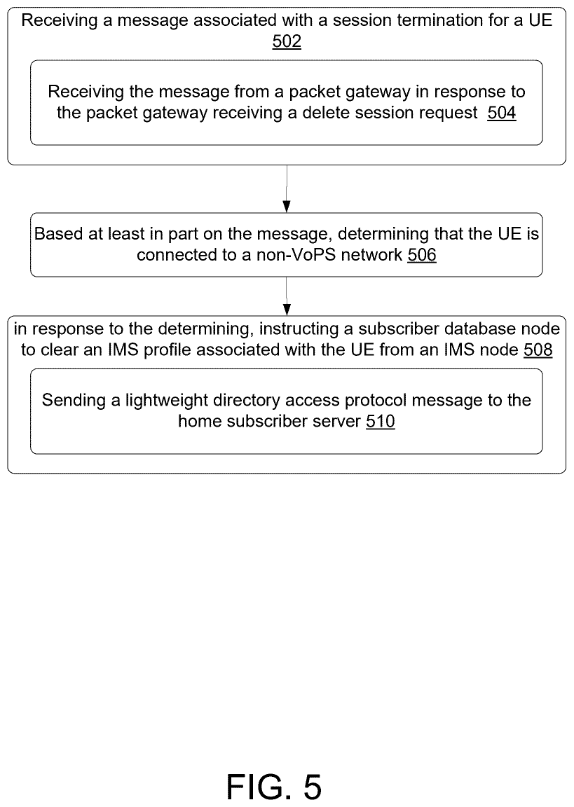

FIG. 5 is a flow diagram of an illustrative process for a policy node to receive a session termination message associated with a UE and to instruct a subscriber database node to delete an IMS profile of the UE from an IMS node. In some implementations, the policy control node may be a PCRF. As illustrated at 502, the policy node receives a message associated with a session termination for a UE. At 504, the receiving may comprise receiving the message from a packet gateway in response to the packet gateway receiving a delete session request.

At 506, based at least in part on the message, the policy node determines that the UE is connected to a non-VoPS network.

At 508, in response to the determining, the policy node instructs a subscriber database node to clear an IMS profile associated with the UE from an IMS node. At 510, the instructing may comprises sending a LDAP message to the home subscriber server.

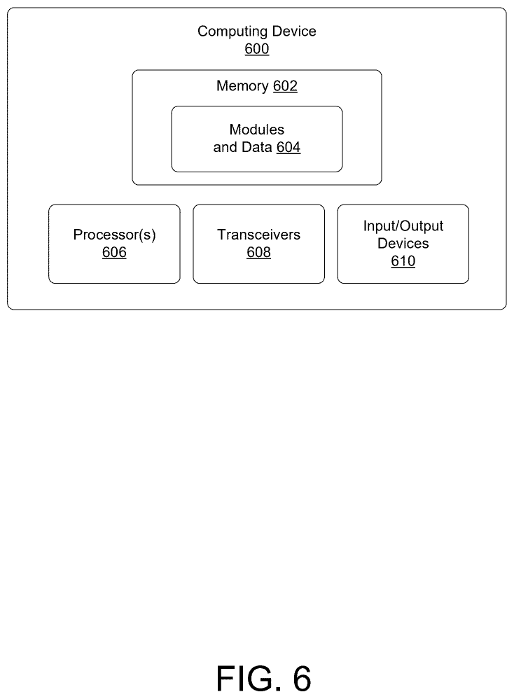

FIG. 6 is a schematic diagram of a computing device capable of implementing functionality of at least one of the subscriber database node or the policy node. As shown, the computing device 600 includes a memory 602 storing modules and data 604, processor(s) 606, transceivers 608, and input/output devices 610.

In various examples, the memory 602 can include system memory, which may be volatile (such as RAM), non-volatile (such as ROM, flash memory, etc.) or some combination of the two. The memory 602 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 602 can include one or more software or firmware elements, such as computer-readable instructions that are executable by the one or more processors 606. For example, the memory 602 can store computer-executable instructions associated with modules and data 604. The modules and data 604 can include a platform, operating system, and applications, and data utilized by the platform, operating system, and applications. Further, the modules and data 604 can implement any of the functionality for the devices and components described and illustrated herein.

In various examples, the processor(s) 606 can be a central processing unit (CPU), a graphics processing unit (GPU), or both CPU and GPU, or any other type of processing unit. Each of the one or more processor(s) 606 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 606 may also be responsible for executing all computer applications stored in the memory 602, which can be associated with types of volatile (RAM) and/or nonvolatile (ROM) memory.

The transceivers 608 can include modems, interfaces, antennas, Ethernet ports, cable interface components, and/or other components that perform or assist in exchanging wireless communications, wired communications, or both.

While the computing device need not include input/output devices 610, in some implementations it may include one, some, or all of these. For example, the input/output devices 610 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 610 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 610 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as Fifth Generation (5G)/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and NTN communications. Thus, the scope of the disclosure is not limited to the examples described herein.

What is claimed is:

1. A method comprising:
receiving, by a subscriber database node of a telecommunications network, a message from another node of the telecommunications network;
based at least in part on the message, determining, by the subscriber database node, that a user equipment (UE) associated with the message is connected to a non-Voice over Packet-Switched (non-VoPS) network; and
in response to the determining, instructing, by the subscriber database node, an Internet Protocol Multimedia Subsystem (IMS) node to delete an IMS profile associated with the UE.

2. The method of claim 1, wherein the message includes a session termination message for an IMS session of the UE.

3. The method of claim 2, wherein the session termination message is a delete session request.

4. The method of claim 3, wherein the delete session request is received by packet data network gateway (PGW)/policy control rules function (PCRF) which sends a further message to the subscriber database node, the delete session request and the further message comprising the message from the other node.

5. The method of claim 1, wherein the message is an update location request.

6. The method of claim 5, wherein the determining comprises checking a table of identifiers of non-VoPS networks available to the subscriber database node in response to receiving the update location request.

7. The method of claim 6, wherein the checking is based on a visited public land mobile network (PLMN) attribute-value pair (AVP) in S6a registration message associated with the UE.

8. The method of claim 5, wherein the determining comprises checking a table of identifiers of VoPS networks available to the subscriber database node in response to receiving the update location request.

9. The method of claim 1, wherein the non-VoPS network is a non-terrestrial network.

10. A subscriber database node of a telecommunications network, comprising:
one or more processors;
a data store listing identifiers of either Internet Protocol Multimedia Subsystem (IMS) networks or of non-IMS networks; and
programming instructions that, when executed by the one or more processors, cause the subscriber database node to perform operations including:
receiving an update location request associated with a user equipment (UE);
based at least in part on the update location request and the data store, determining that the UE is connected to a non-IMS network; and
in response to the determining, instructing a serving node of an IMS of the telecommunications network to delete an IMS profile associated with the UE.

11. The subscriber database node of claim 10, wherein the subscriber database node is a home subscriber server.

12. The subscriber database node of claim 10, wherein the determining comprises checking to see if an identifier of the non-IMS network that the UE is connected to is included when data store lists non-IMS networks or is not included when data store lists IMS networks.

13. The subscriber database node of claim 12, wherein the checking is based on a visited public land mobile network (PLMN) attribute-value pair (AVP) in S6a registration message associated with the UE.

14. The subscriber database node of claim 10, wherein the data store lists mobile country codes (MCC) and/or mobile network codes (MNC) of networks.

15. The subscriber database node of claim 14, wherein the data store lists MCCs/MNCs of both IMS and non-IMS networks, and either the IMS networks or the non-IMS networks are indicated by flag values.

16. The subscriber database node of claim 10, wherein the serving node is a serving call session control function (S-CSCF).

17. A non-transitory computer storage medium having programming instructions stored thereon that, when executed by one or more processors of a computing device, cause the computing device to implement a policy control node to perform operations comprising:
receiving a message associated with a session termination for a User Equipment (UE);
based at least in part on the message, determining that the UE is connected to a non-Voice over Packet-Switched (non-VoPS) network; and
in response to the determining, instructing a subscriber database node to clear an Internet Protocol Multimedia Subsystem (IMS) profile associated with the UE from an IMS node.

18. The non-transitory computer storage medium of claim 17, wherein the message is received from a packet gateway in response to the packet gateway receiving a delete session request.

19. The non-transitory computer storage medium of claim 17, wherein the policy control node is a policy and charging rules function (PCRF).

20. The non-transitory computer storage medium of claim 17, wherein the instructing comprises sending a lightweight directory access protocol message to the subscriber database node.
